(19) United States
(12) Patent Application Publication
(10) Pub. No.: US 2014/0133680 A1
(43) Pub. Date: May 15, 2014

(54) Electrostatic Loudspeaker with Multichannel Output

(71) Applicant: RAYTREND TECHNOLOGY CORP., New Taipei City (TW)

(72) Inventors: Meng-Yu Lee, New Taipei City (TW); Chung-Yang Lin, New Taipei City (TW)

(73) Assignee: RAYTREND TECHNOLOGY CORP., New Taipei City (TW)

(21) Appl. No.: 13/762,555

(22) Filed: Feb. 8, 2013

(30) Foreign Application Priority Data
Nov. 9, 2012 (TW) 101221775

(51) Int. Cl. H04R 19/02

(52) U.S. Cl. CPC H04R 19/02
USPC 381/191

(57) ABSTRACT

An electrostatic loudspeaker with multichannel output includes an electrostatic diaphragm, spacers, a first electrode plate and a second electrode plate. The electrostatic diaphragm has two outer surfaces, and a spacer is disposed on each outer surface. The spacers and the electrostatic diaphragm are sandwiched between the first and second electrode plates. At least two metal layers that do not overlap each other are respectively disposed on each of the first and the second electrode plates, and are electrically connected to at least two different electric contacts respectively, so as to obtain at least two corresponding sound source signals. In this manner, at least two metal layers attract or repel the electrostatic diaphragm, causing the electrostatic diaphragm to vibrate and generate sound respectively. In this presentation, at least two sound source signals may be applied to the same electrostatic loudspeaker, thereby achieving the objective of multichannel output.

### CROSS-REFERENCES TO RELATED APPLICATIONS

This non-provisional application claims priority under 35 U.S.C. §119(a) on Patent Application No. 101221775 filed in Taiwan, R.O.C. on Nov. 9, 2012, the entire contents of which are hereby incorporated by reference.

### BACKGROUND OF THE INVENTION

1. Technical Field

The present invention relates to an electrostatic loudspeaker, and more particularly to an electrostatic loudspeaker with multichannel output.

2. Related Art

With the rapid development of science and technology, many electronic products have become intensively diversified. In recent years, light, thin, and small electronic products are most popular among consumers, because these products are portable and save storage spaces. A loudspeaker for generating sound on the market is an example.

In a traditional loudspeaker placed on the ground or on a desk, a single sound generator is disposed in a box. The box of the loudspeaker has a large size, which affects the portability and occupies an excessive storage space.

Recently, an electrostatic loudspeaker (so-called paper loudspeaker), is available on the market, in which a flexible upper spacer and a flexible upper electrode plate are disposed above a diaphragm, and a flexible lower spacer and a flexible lower electrode plate are disposed below the diaphragm. Each of the upper and lower electrode plates has an upper metal layer and a lower metal layer. The upper and lower metal layers are each electrically connected to a sound source signal line. After a sound source signal is obtained through the sound source signal line, electric ions are respectively distributed on the upper and lower metal layers in response to the sound source signal, so as to attract or repel the diaphragm. Consequently, the diaphragm can vibrate in response to the sound source signal, thereby generating sound so that a user can hear.

A flexible material is used in the electrostatic loudspeaker, so the electrostatic loudspeaker can be folded, which facilitates portability and saves the storage space. However, only a single sound source signal can be output, that is, multichannel output cannot be implemented in the electrostatic loudspeaker. If multichannel output is required, multiple electrostatic loudspeakers must be used and electrically connected to different sound source signal lines, so as to obtain different sound source signals to achieve the objective of multichannel output. However, this manner also affects the portability, and even if all electrostatic loudspeakers are folded before being stored, the entire size is increased, making storage difficult.

### SUMMARY

In view of the above problems, the present invention provides an electrostatic loudspeaker with multichannel output, so as to achieve the objective of multichannel output without using multiple loudspeakers.

The technical solution used for achieving the above objective is an electrostatic loudspeaker, which includes:

an electrostatic diaphragm, having two opposite outer surfaces;

two spacers, respectively disposed on the two outer surfaces of the electrostatic diaphragm, each spacer having at least two hollow areas for exposing the electrostatic diaphragm, and the at least two hollow areas of the two spacers being opposite each other;

a first electrode plate, including a first substrate and at least two first metal layers, in which the at least two first metal layers are formed on the first substrate without overlapping each other and respectively correspond to the at least two hollow areas, the first substrate is provided with a plurality of through holes that runs through the corresponding at least two first metal layers, and each of the at least two first metal layers is connected with a first electric contact; and

a second electrode plate, including a second substrate and at least two second metal layers, in which the at least two first metal layers are formed on the second substrate without overlapping each other and respectively correspond to the at least two hollow areas, the second substrate is provided with a plurality of via holes that runs through the corresponding at least two second metal layers, and each of the at least two second metal layers is connected with a second electric contact.

The first electrode plate and the second electrode plate are respectively disposed at two external sides of the two spacers.

The electrostatic loudspeaker having the above structure mainly has at least two sound source signals electrically connected to the first and second electric contacts respectively, so that each first metal layer on the first electrode plate and each second metal layer on the second electrode plate may have corresponding sound source signals, and that each first metal layer and each second metal layer may respectively attract or repel the electrostatic diaphragm, making the electrostatic diaphragm vibrate correspondingly, thereby outputting corresponding sound waves to be heard by users. The electrostatic diaphragm corresponds to vibrations of all first metal layers and second metal layers, so the electrostatic diaphragm can output sound waves separately, that is, the same electrostatic loudspeaker may output multiple sound waves, indicating that the electrostatic loudspeaker of the present invention has multiple output channels, achieving the objective of multichannel output, thereby facilitating portability and storage for users.

### BRIEF DESCRIPTION OF THE DRAWINGS

The present invention will become more fully understood from the detailed description given herein below for illustration only, and thus not limitative of the present invention, wherein:

FIG. 1 is a three-dimensional view of an embodiment of the present invention;

FIG. 2 is an exploded view of FIG. 1;

FIG. 3 is a top view of FIG. 1;

FIG. 4 is a sectional view of FIG. 3 along a sectional line AA;

FIG. 5 is a schematic view of a second embodiment of the present invention; and

FIG. 6 is a schematic view of a third embodiment of the present invention.

### DETAILED DESCRIPTION

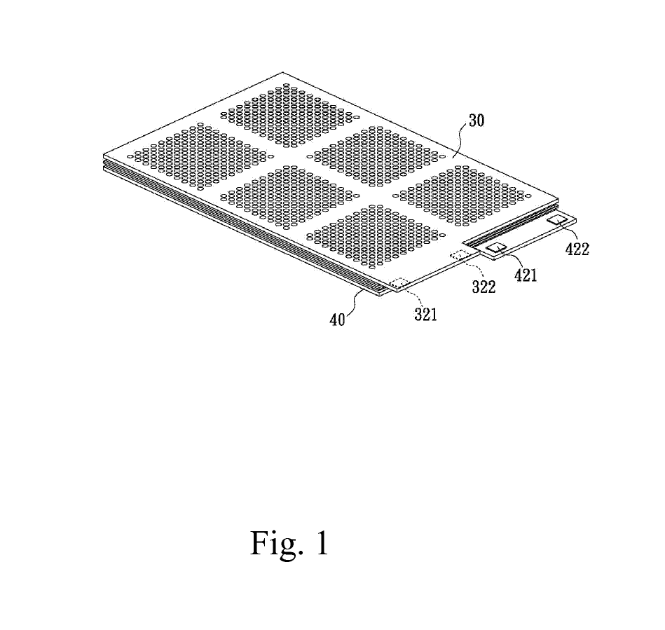

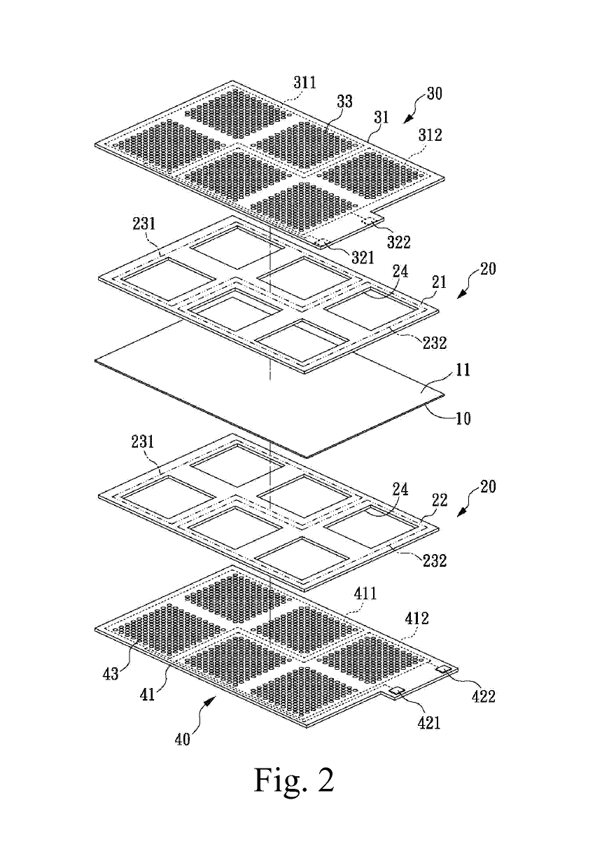

FIG. 1 is a three-dimensional view of an embodiment of the present invention. FIG. 2 is an exploded view of FIG. 1. Please refer to FIG. 1 and FIG. 2, in which an electrostatic loudspeaker of the present invention includes an electrostatic diaphragm 10, two spacer 20, a first electrode plate 30 and a second electrode plate 40.

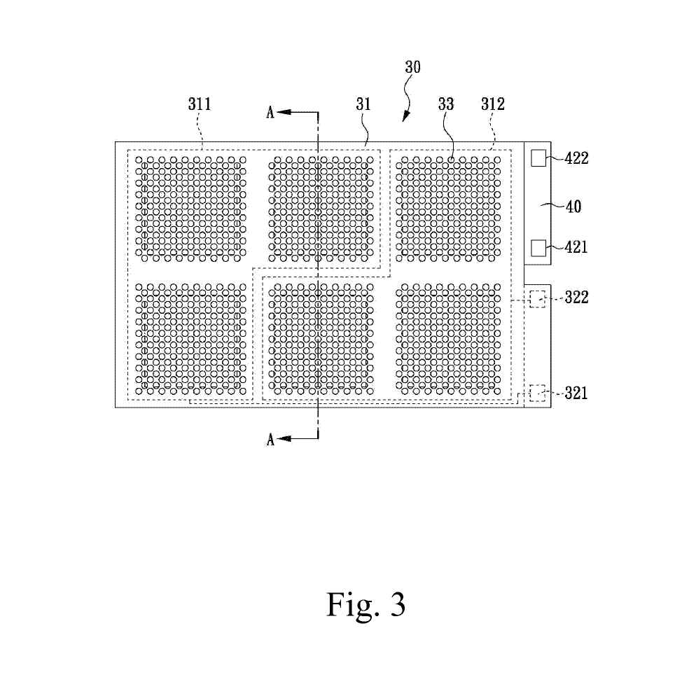

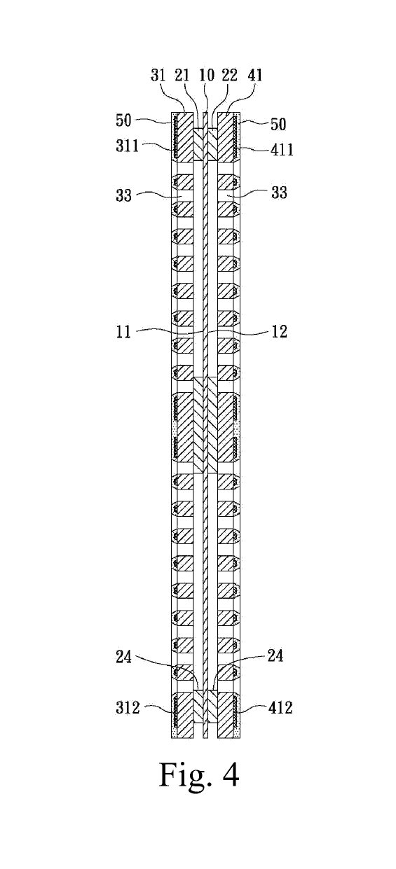

FIG. 3 is a top view of FIG. 1. FIG. 4 is a sectional view of FIG. 3 along a sectional line AA. Please refer to FIG. 4, in which the electrostatic diaphragm 10 has a first outer surface 11 and a second outer surface 12. The second outer surface 12 is opposite the first outer surface 11. In this embodiment, the electrostatic diaphragm 10 is substantially a rectangular sheet body, and is flexible. In this embodiment, the electrostatic diaphragm 10 is an electric diaphragm. In other embodiments, other manners may be used, for example, the electrostatic diaphragm is electrically connected to a bias power supply (not shown) to obtain a reference voltage.

Please refer to FIG. 2, in which the spacer 20 has an upper spacer 21 and a lower spacer 22. The upper spacer 21 is disposed on the first outer surface 11, and the lower spacer 22 is disposed on the second outer surface 12. The upper and lower spacers 21 and 22 are each provided with at least two hollow areas 231 and 232 that expose the electrostatic diaphragm 10. The at least two hollow areas 231 and 232 of the upper and lower spacers 21 and 22 are opposite each other. In this embodiment, the upper and lower spacers 21 and 22 each have a left hollow area 231 and a right hollow area 232, and the left and right hollow areas 231 and 232 each at least have a hollow hole 24.

The first electrode plate 30 includes a first substrate 31. Please refer to FIG. 2, in which the first substrate 31 has at least two first metal layers 311 and 312 that do not overlap each other. In this embodiment, the first substrate 31 has a left first metal layer 311 and a right first metal layer 312. Please refer to FIG. 3, in which the left first metal layer 311 is located at the left side of FIG. 3. The right first metal layer 312 is located at the right side of FIG. 3. The left first metal layer 311 is connected with a left first electric contact 321, and the right first metal layer 312 is connected with a right first electric contact 322. Additionally, the first substrate 31 has a plurality of through holes 33. The through holes 33 respectively run through the first substrate and correspond to the left first metal layer 311 and the right first metal layer 312. Please refer to FIG. 4, in which the left first metal layer 311 and the right first metal layer 312 are respectively located at external sides of the first substrate 31. In some embodiments, the left first metal layer 311 and the right first metal layer 312 may be located at internal sides of the first substrate 31.

The architecture of the second electrode plate 40 is similar to that of the first electrode plate 30. The second electrode plate 40 includes a second substrate 41. The second substrate 41 has at least two second metal layers 411 and 412 that do not overlap each other. In this embodiment, the second substrate 41 has a left second metal layer 411 and a right second metal layer 412. The left second metal layer 411 is connected with a left second electric contact 421, and the right second metal layer 412 is connected with a right second electric contact 422. Additionally, the second substrate 41 has a plurality of via holes 43. The via holes 43 respectively run through the second substrate and correspond to the left second metal layer 411 and the right second metal layer 412. In this embodiment, the left second metal layer 411 is located at the left side of the second substrate 41. Correspondingly, the right second metal layer 412 is located at the right side of the second substrate 41. Please refer to FIG. 4, in which the left second metal layer 411 and the right second metal layer 412 are respectively located at external sides of the second substrate 41. In some embodiments, the second metal layer 411 or the right second metal layer 412 may be located at an internal side of the second substrate 41. In this embodiment, the first substrate 31 and the second substrate 41 are each a flexible printed circuit.

In this embodiment, the left second metal layer 411 corresponds to the left first metal layer 311 through the left hollow area 231. In the same manner, the right second metal layer 412 corresponds to the right first metal layer 312 through the right hollow area 232. In addition, the first electrode plate 30 is disposed at an external side of the upper spacer 21, that is, the first electrode plate 30 is located at a side of the upper spacer 21 where the upper spacer 21 does not face the electrostatic diaphragm 10. Similar to the above architecture, the second electrode plate 40 is disposed at an external side of the lower spacer 22. Therefore, the electrostatic diaphragm 10 and the upper and lower spacers 21 and 22 are sandwiched between the first electrode plate 30 and the second electrode plate 40.

In this embodiment, Please refer to FIG. 4, in which each of outer surfaces of the first electrode plate 30 and second electrode plate 40 further includes a protection layer 50. The protection layer 50 covers the left first metal layer 311, the right first metal layer 312, the left second metal layer 411 and the right second metal layer 412. The protection layer 50 is used to prevent the user from touching the left and right first metal layers 311 and 312 and the left and right second metal layers 411 and 412 by mistake, thereby preventing incomplete vibration and sound distortion of the electrostatic diaphragm 10.

In some embodiments, the left first metal layer 311 may be located at an internal side of the first substrate 31, that is, the left first metal layer 311 faces the electrostatic diaphragm 10. In the same manner, the right first metal layer 312 may be located at an internal side of the first substrate 31. In addition, the left second metal layer 411 or the right second metal layer 412 may be located at an internal side of the second substrate 41.

In the electrostatic loudspeaker having the above structure, the left first and second electric contacts 321 and 421 are electrically connected to a positive contact and a negative contact of a left channel signal line respectively; the right first and second electric contacts 322 and 422 are electrically connected to a positive contact and a negative contact of a right channel signal line respectively. Therefore, when a left (right) channel signal is input to the left (right) channel signal line, electric ions corresponding to the left (right) channel signal are distributed on the left (right) first metal layer 311 and the left (right) second metal layer 411. Corresponding to positive and negative electric ions of the electrostatic diaphragm 10, the left (right) first metal layer 311 and the left (right) second metal layer 411 can attract or repel the electrostatic diaphragm 10 and further cause the electrostatic diaphragm 10 to vibrate.

Therefore, if positive (negative) electric ions are distributed on the left first metal layer 311 to attract the electrostatic diaphragm 10, then negative (positive) electric ions are distributed on the opposite left second metal layer 411 to repel the electrostatic diaphragm 10, so that the electrostatic diaphragm 10 is bended toward the left first metal layer 311. In the same manner, if positive (negative) electric ions are distributed on the right first metal layer 312 to attract the electrostatic diaphragm 10, then negative (positive) electric ions are distributed on the opposite right second metal layer 412 to repel the electrostatic diaphragm 10, so that the electrostatic diaphragm 10 is bended toward the right first metal layer 312.

Therefore, when left channel signals are input continuously, the positive (negative) electric ions on the left first metal layer 311 and the left second metal layer 312 are correspondingly increased or decreased, thereby enhancing or reducing the attraction force or repelling force thereof on the electrostatic diaphragm 10. Therefore, the electrostatic diaphragm 10 is enabled to vibrate continuously, generating sound waves with corresponding amplitudes and frequencies, thereby generating sound to be heard by the user. In the same manner, if right channel signals are input continuously, the electrostatic diaphragm 10 is also enabled to generate sound waves with corresponding amplitudes and frequencies to be heard by the user. The first electrode plate 30 has the left first metal layer 311 and the right first metal layer 312, and the opposite second electrode plate 40 has the left second metal layer 411 and the right second metal layer 412. Therefore, when the left and right channel signals are continuously input, the electrostatic diaphragm 10 can be attracted or repelled at the same time and output sound waves respectively corresponding to the left and right channels, thereby achieving the objective of multichannel output. The user can enjoy a surrounding sound effect only using one electrostatic loudspeaker. Moreover, such a structure facilitates portability or storage for users.

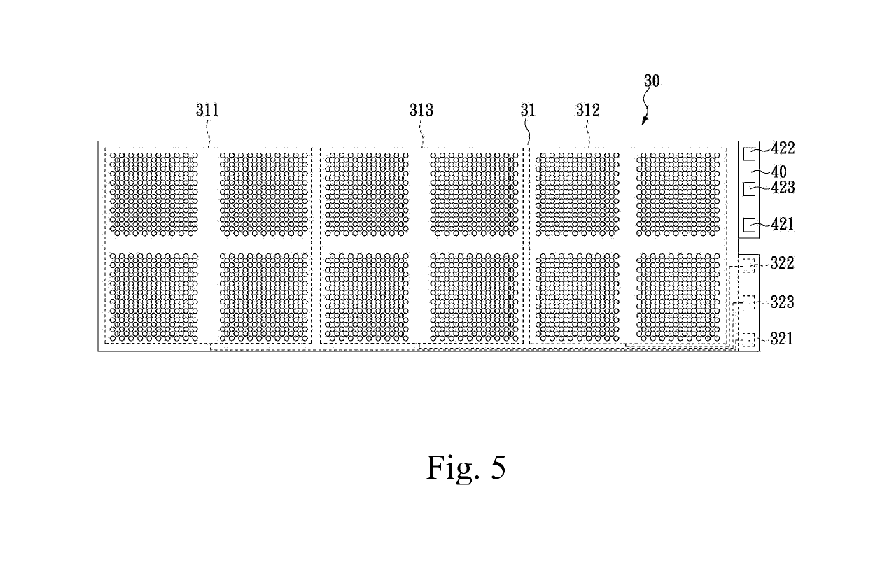

FIG. 5 is a schematic view of a second embodiment of the present invention, and the basic architecture thereof is substantially the same as the foregoing embodiment. Please refer to FIG. 5, in which an electrostatic diaphragm 10, a spacer 20, a first electrode plate 30, and a second electrode plate 40 are included. The difference lies in that, the first electrode plate 30 further includes an accent first metal layer 313, which does not overlap the left first metal layer 311 or the right first metal layer 312. The accent first metal layer 313 is electrically connected to a bass electric contact 323. In the same manner, the second electrode plate 40 also includes an accent second metal layer (not shown), which is electrically connected to another bass electric contact 423. The two bass electric contacts 323 and 423 are electrically connected to an accent signal line and obtain an accent signal thereof. This apparatus can then generate an accent, and in coordination with the original output of the left and right channels, the electrostatic loudspeaker can output the sound of 2.1 channels.

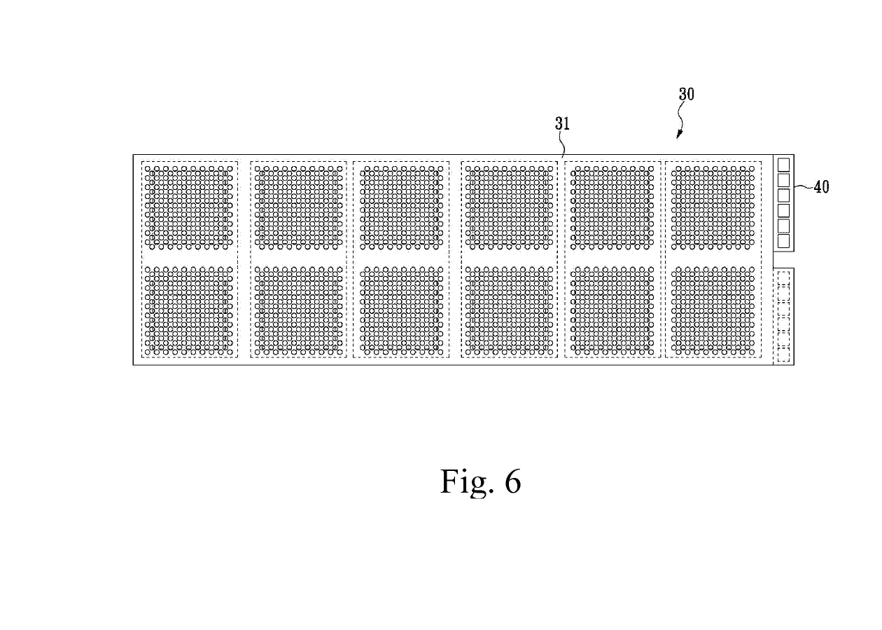

Additionally, FIG. 6 is a schematic view of a third embodiment of the present invention, which is similar to the foregoing embodiment. The difference lies in the fact that the first and second electrode plates 30 and 40 are each provided with six first and second metal layers that do not overlap each other. Each metal layer is connected to an electric contact and used to be connected to a corresponding channel signal line. In this manner, the electrostatic loudspeaker can output the sound of 5.1 channels, so that the user can enjoy a surrounding sound effect. In some embodiments, the first and second electrode plates 30 and 40 each has 8 or 12 metal layers to output the sound of 8 channels or 12 channels, so that the user can hear better stereophonic sound, and feel personally on the scene.

While the present invention has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. An electrostatic loudspeaker with multichannel output, comprising:
an electrostatic diaphragm, having two opposite outer surfaces;
two spacers, respectively disposed on the two outer surfaces of the electrostatic diaphragm, each spacer having at least two hollow areas for exposing the electrostatic diaphragm, and the at least two hollow areas of the two spacers being opposite each other;
a first electrode plate, comprising a first substrate and at least two first metal layers, wherein the at least two first metal layers are formed on the first substrate without overlapping each other and respectively correspond to the at least two hollow areas, the first substrate is provided with a plurality of through holes that runs through the corresponding at least two first metal layers, and each of the at least two first metal layers is connected with a first electric contact; and
a second electrode plate, comprising a second substrate and at least two second metal layers, wherein the at least two second metal layers are formed on the second substrate without overlapping each other and respectively correspond to the at least two hollow areas, the second substrate is provided with a plurality of via holes that runs through the corresponding at least two second metal layers, and each of the at least two second metal layers is connected with a second electric contact;
wherein, the first electrode plate and the second electrode plate are respectively disposed at two external sides of the two spacers.

2. The electrostatic loudspeaker with multichannel output according to claim 1, wherein the two spacers are respectively an upper spacer and a lower spacer; the upper spacer is located between the first electrode plate and the electrostatic diaphragm, and the lower spacer is located between the second electrode plate and the electrostatic diaphragm.

3. The electrostatic loudspeaker with multichannel output according to claim 2, wherein the at least two hollow areas of the upper spacer comprise a left hollow area and a right hollow area; the at least two hollow areas of the lower spacer comprise a left hollow area and a right hollow area.

4. The electrostatic loudspeaker with multichannel output according to claim 3, wherein the at least two first metal layers of the first electrode plate comprise a left first metal layer and a right first metal layer; the left first metal layer corresponds the left hollow area of the upper spacer, and the right first metal layer corresponds to the right hollow area of the upper spacer;
wherein, the at least two second metal layers of the second electrode plate comprise a left second metal layer and a right second metal layer; the left second metal layer corresponds to the left hollow area of the lower spacer, and the right second metal layer corresponds to the right hollow area of the lower spacer.

5. The electrostatic loudspeaker with multichannel output according to claim 1, wherein each of the at least two hollow areas of the two spacers has at least one hallow hole.

6. The electrostatic loudspeaker with multichannel output according to claim 1, wherein the at least two first metal layers of the first electrode plate are electrically connected to at least two different first electric contacts respectively; the at least two second metal layers of the second electrode plate are electrically connected to at least two different second electric contacts respectively.

7. The electrostatic loudspeaker with multichannel output according to claim 6, wherein the at least two different first electric contacts comprise a left first electric contact and a right first electric contact; the at least two different second electric contacts comprise a left second electric contact and a right second electric contact.

8. The electrostatic loudspeaker with multichannel output according to claim 7, wherein the left first electric contact and the left second electric contact are electrically connected to a positive contact and a negative contact of a left channel signal line respectively, so as to obtain a left channel signal; the right first electric contact and the right second electric contact are electrically connected to a positive contact and a negative contact of a right channel signal line respectively, so as to obtain a right channel signal.

9. The electrostatic loudspeaker with multichannel output according to claim 1, wherein the electrostatic diaphragm is an electric diaphragm.

10. The electrostatic loudspeaker with multichannel output according to claim 1, wherein each of outer surfaces of the first electrode plate and the second electrode plate has a protection layer that covers the at least two first metal layers and the at least two second metal layers.

11. The electrostatic loudspeaker with multichannel output according to claim 1, wherein the at least two first metal layers are respectively formed at an external side of the first substrate.

12. The electrostatic loudspeaker with multichannel output according to claim 1, wherein the at least two second metal layers are respectively formed at an external side of the second substrate.

13. The electrostatic loudspeaker with multichannel output according to claim 1, wherein the first substrate and the second substrate are each a flexible printed circuit substrate.
